(19) United States
(12) Patent Application Publication
(10) Pub. No.: US 2026/0260960 A1
(43) Pub. Date: Sep. 3, 2026

(54) BATTERY CELL WITH ELECTRODE, ELECTRICALLY AND THERMALLY CONDUCTIVE COLLECTOR, WITH INTERNAL AND EXTERNAL HEAT EXCHANGER

(71) Applicant: Raul-Ioan RISCO, Pitesti, Arges (RO)

(72) Inventor: Raul-Ioan Risco, Pitesti (RO)

(21) Appl. No.: 18/872,847

(22) PCT Filed: May 26, 2023
(86) PCT No.: PCT/RO2023/050007

§ 371 Date: Dec. 11, 2024

(30) Foreign Application Priority Data
Jun. 20, 2022 (RO) A202200352

(51) Int. Cl. H01M 10/654; H01M 10/42; H01M 10/48; H01M 10/613; H01M 10/647; H01M 10/653; H01M 10/6563; H01M 10/6567; H01M 50/103; H01M 50/105; H01M 50/136; H01M 50/204; H01M 50/293; H01M 50/46; H01M 50/538

(52) U.S. Cl. CPC H01M 10/654; H01M 10/425; H01M 10/48; H01M 10/613; H01M 10/647; H01M 10/653; H01M 10/6563; H01M 10/6567; H01M 50/103; H01M 50/105; H01M 50/136; H01M 50/204; H01M 50/293; H01M 50/46; H01M 50/538; H01M 2010/4271

(57) ABSTRACT

Battery cell, with rolled electrodes, with at least one border of bent poles to form a base at at least one end, wherein it is continued with a wool cushion bridge, electrothermal conductor collector at the battery cell terminal, encapsulated assembly, sealed in a composite box with a flexible, elastic, electrically insulating body, which is also an expansion vessel in the event of the formation of an internal gas due to the electrochemical reaction between the anode and the cathode, housing and storing the flammable gas inside, sealed with the outside, and the pressure is measured in real time by an internal pressure sensor that transmits the data in real time to the BMS and/or to the battery cell controller. The battery cells are provided with heat exchanger device and are assembled into modules and racks, with air or air-liquid hybrid passive or forced cooling system.

This invention relates generally to energy cells and electrical storage devices. More particularly, the present invention relates to electrodes having a sponge or wool cushion for extension and compression, an electrode bridge, for direct and continuous electrical conductivity between poles and terminals, but also thermal conductivity, being an internal heat exchanger device, for homogeneous cooling of the poles. The conductor collector bridge features elasticity and flexibility, as well as electro-thermal tightness at encapsulation by maintaining the contact pressure directly with the poles and terminals, where it moulds on all surfaces. The pressure on the collector bridge can be exerted by a flexible and elastic body of the battery cell box, which can be located between the ends or between the terminals of the battery cell, the body being part of the battery cell box structure, being a composite box.

In the battery cell, there is at least one current collector plate that is welded to a core exposed to the portion where a conductor of positive or negative electrodes is located, and this collector conducts current to an external output terminal. In high-power batteries, it is important that the current collector also conducts the high current to the external output in a stable manner. Within the purpose of a higher conductivity of a stable high current, it is advantageous to extend the contact area between the current collector plate and the core of the positive and/or negative electrodes, to increase the contact area and direct contact pressure between the collectors and the electrodes, but also to remove welds. Further, the electrodes generate heat that cannot be transmitted to the terminals or to the outside, because the contact surface of the collector plate is minimal and the heat transfer is obstructed.

However, in a high-capacity laminated battery cell with a high number of windings or layers, it is not easy to extend a contact area between the current collector plate and the positive and/or negative electrode cores and, as a result, high current and heat from the electrodes cannot be conducted, causing overheating. The thermal conductivity needed by the electrodes for cooling is affected to the same extent, being strangled (obstructed) due to the collector that does not sufficiently conduct thermal energy through the collector or through their welds.

These problems are solved in the present invention by using a current and heat conductor collector bridge device, a cushion made of wool mesh or compression and contact sponge, with a larger surface area than before, increasing the contact area between the current and heat conductor collector device and the electrodes of the battery cell, respectively with the poles, anode and/or cathode, device that maintains the contact pressure exerted on the electrodes, increasing its contact surface by pressure and deformation, with mirror effect on the terminals as well, this device being referred to in the present invention as electrically and thermally conductive collector bridge, made of an electrically and thermally conductive material, being a cushion made of wool mesh and compression sponge inside the battery cell.

In terms of thermal conductivity, the contact surface area increased by the device of the present invention, which extends the contact surface area between terminals and electrodes, ensures thermal conductivity and constant cooling over the entire surface required for electrodes in and from the battery cell.

By means of the present invention, heat is removed from the battery cell through the conductor collector bridge, directly from the electrodes, and cooling by external heat exchangers of the battery cells is also ensured at battery cell external level, homogeneously, constantly and rapidly through a continuous electrical and thermal flow chain, inside-outside. The solution to the technical problems is presented in the independent claims 1, 7, 8, 10, creating preferences of the invention for solution and execution in the dependent claims 2, 3, 4, 5, 6, 9 and they make the object they depend on.

It will be appreciated that one or more of the elements depicted in the drawings/figures can also be implemented in a more separate or integrated manner, or even eliminated in certain cases, as useful in accordance with a particular application.

Also, the rates, dimensions, distances, scale, sizes and proportions in the figures, but not limited thereto, are only for understanding and explaining the present invention, in order to present the solutions to the problems.

The terms box, housing, capsule, are used to describe the packaging of the battery cell, the impermeability and sealing of the battery cell, and the tightness of the battery cell.

The term continuous flow chain is a reversible and bidirectional path, of electrical and/or thermal type, without constraint of space, surface, area, mechanical constraint such as welding or touch and contact, such path being between at least two elements of the present invention.

The terms wool mesh and compression sponge cushion refer to an elastic or semi-elastic, deformable, compressible device that takes a shape by compression, deformation, pressure or crushing, occupying a specific and/or variable space and can be made of, without limitation to, fabric, wires or blades, provided that they have the properties described, and made of the material with electrical and/or thermal conductivity properties specified as reference material in the present invention for the contactor collector bridge and/or as reference material in the present invention for the heat exchanger. The connector collector bridge inside the battery cell described herein may be made of, without limitation to, copper, as long as it is a material with the properties described for the bridge. The heat exchanger on the outside of the battery cell of the present invention may be made of copper or Boron Nitride or Boron Nitride Composite and/or in mixture hereto, without limitation to copper or Boron Nitride, as long as it is a material with the properties described for the external heat exchanger. The elastic and/or flexible body of the box, which can be located in the middle and/or axially between the terminals of the battery cell, can be made of silicone material, but not limited to silicone, as long as it is a material with the properties described for the body of the battery cell.

The present invention relates to a battery cell with at least one assembly of anode/cathode electrodes, which can therefore be used to form an electrical energy storage device having at least one bridge, the electrical and thermal conductor collector, of electrically and thermally conductive material, being a cushion made of wool mesh and compression sponge inside the battery cell, a bridge for continuous contact between at least one electrode, anode and/or cathode, which can be through the pole or bent and forming the base of the electrode and its terminal, the bridge increasing the electrical and thermal transfer from inside the battery cell to its outside, directly from the battery cell electrodes to its outside, reducing the internal resistance of the battery cell, reducing the cost of materials and manufacturing, the bridge being in turn connected through the battery cell terminal or through the surface of the battery cell box with another heat exchanger located outside the battery cell, made of another thermally conductive material, being another cushion made of wool mesh and compression sponge outside the battery cell in contact with the outside of the battery cell, which takes over the heat inside the battery cell, forming an unobstructed continuous thermodynamic chain, from the inside to the outside and up to the passive or forced cooling source of the entire system, scalable from the battery cell, to the module, block, pack, rack and containerization.

### DESCRIPTION OF THE DRAWINGS

Other advantages of the invention are obvious by reference to the detailed description when considered in accordance with the figures, which are not to scale, in order to show more clearly the details, in which similar reference numbers represent similar elements in several views and in which:

FIG. 1—shows a perspective view of an electrode assembly, anode-cathode, with at least one separator, in accordance with certain embodiments of the present invention.

FIG. 2—shows a vertical section of the battery cell components, in accordance with certain embodiments of the present invention.

FIG. 3—shows the side view of the base and its components, in accordance with certain embodiments of the present invention.

FIG. 4—shows a partial vertical section of the components of the battery cell with external heat exchanger, in accordance with certain embodiments of the present invention.

FIG. 5—shows design details of the battery cell with current reverser, electrical insulation and thermal conductor, in accordance with certain embodiments of the present invention.

FIG. 6—shows an aspect of the elastic and flexible body, between the ends of the battery cell and/or between the terminals of the battery cell, in accordance with certain embodiments of the present invention.

FIG. 7—shows design details of the battery cell, in accordance with certain embodiments of the present invention.

FIG. 8—shows the design details of the contact heat exchanger on the outside of the battery cells in accordance with certain embodiments of the present invention.

FIG. 9—shows a view of the heat exchanger on battery cells, made of thermally conductive material, wool mesh and compression sponge cushion on the outside of the battery cells, in contact with and attached to the outside of the prismatic battery cells, in accordance with certain embodiments of the present invention.

FIG. 10—shows a view of the heat exchanger to the battery cells, made of material thermally conductive, wool mesh and compression sponge cushion outside the battery cells, in contact with and attached to the outside of the pouch battery cells, in accordance with certain embodiments of the present invention.

FIG. 11—shows a battery cell module with heat exchangers composed of wool mesh and compression sponge cushion on the outside of the battery cells assembled in the module, in horizontal section, with hybrid air-liquid forced cooling, in accordance with certain embodiments of the present invention.

FIG. 12—shows a battery cell module in vertical view, with reference to FIG. 11. with hybrid air-liquid forced cooling in accordance with certain embodiments of the present invention.

FIG. 13—shows an assembly of modules, with reference to FIG. 11 and FIG. 12, representing the scalability of battery cell modules, with central hybrid air-liquid forced cooling, in accordance with certain embodiments of the present invention.

FIG. 14—shows the continuous electric flow chain of the present invention.

FIG. 15—shows the continuous thermal flow chain of the present invention.

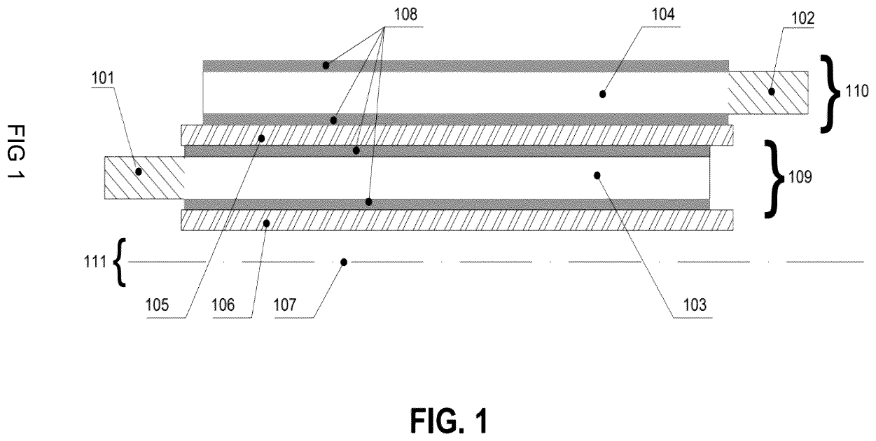

As such, in the preferred embodiments of the present invention, the battery cell contains at least one electrode assembly 109/FIG. 1 and 110/FIG. 1, anode and cathode, covered up to the border of the poles with active composite material 101/FIG. 1 and 102/FIG. 1, mirror-disposed coating, where the border 101/FIG. 1 pole of the anode is opposite the border 102/FIG. 1 pole of cathode.

Referring to FIG. 1, two band-shaped electrodes 103/FIG. 1 and 104/FIG. 1 are shown, with active composite matter 108/FIG. 1 covering the electrodes partially up to the pole area 101/FIG. 1 and 102/FIG. 1, with internal separator 106/FIG. 1 and the separator which may be external 105/FIG. 1 used to form a rechargeable battery cell, an assembly that forms a core rolled around the axis 107/FIG. 1, with electrode ends without composite active matter, i.e. the poles 101/FIG. 1 and 102/FIG. 1, according to an embodiment of the present invention.

The electrode assembly of FIG. 1 can be used to form a single-cell or multi-cell rechargeable battery.

When forming the electrode assembly, the electrodes 109/FIG. 1, 110/FIG. 1 and separators 105/106/FIG. 1, are stacked and then wrapped together around a central axis 107/FIG. 1, so that the central gap 111/FIG. 1 is formed, or a central nucleus of a square and/or elastic shape, for rolling compression, but not limited to a square geometric shape. In the illustrated embodiment, the electrode 103/FIG. 1 can be an anode and the electrode 104/FIG. 1 can be a cathode, and the separators 105 and/or 106/FIG. 1, insulate electrically in order to prevent a short circuit, and the poles 101 and 102/FIG. 1, are perpendicularly axially opposite, without coming into contact between a pole of the anode with one or any pole of the cathode.

In some embodiments, the electrically conductive coating comprises an active composite material for electrodes, in some embodiments, the active composite material of the electrode is a cathodic active material. In some embodiments, the active composite material of the electrode is an anodic active material, and the active material of the electrode is selected from a silicon material (e.g., metallic silicon and silicon dioxide), graphite materials, graphite, graphene-containing materials, hard carbon, soft carbon, carbon, nanotubes, porous carbon, conductive carbon, lithium nickel, manganese, cobalt, oxide (NMC), lithium manganese oxide (LMO), lithium cobalt oxide (LCO), lithium titanate, lithium titanate, nickel oxide, aluminium cobalt (NCA), a stratified transitional metal oxide (such as LiCo02 (LCO), Li (NiMnCo) 02 (NMC) and/or LiNio.8 C00.15Alo. 050, (NCA)), a manganese spinel oxide (such as LiMn 04 (LMO) and/or LiMn, Ni. 04 (LMNO)), an olivine (such as LiFePO4), chalcogens (LiTiS), tavorite (LiFeSO4F), silicon, silicon oxide (SiOx), tin, aluminium, tin oxide (SnOx), manganese oxide (MnOx), molybdenum oxide (M0) 02), molybdenum disulphide (MoS2), nickel oxide (NiOx), copper oxide (CuOx) and lithium sulphide (Li, S) or combinations thereof. In some embodiments, the first layer further comprises a binder.

Some examples of active composite arrangement include, but are not limited to, mechanical deposition, electromechanical deposition, electrochemical deposition, or any combination of processes known to the ones skilled in the art, a process equivalent also for depositions 108/FIG. 1 of the electrode substrates 103/FIG. 1 and 104/FIG. 1.

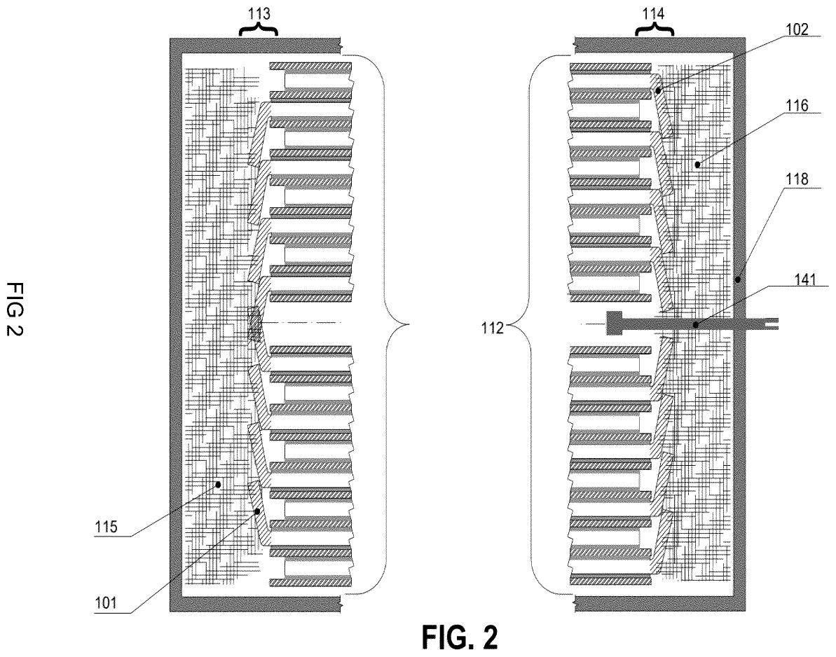

With continuous reference to FIG. 1 and also shown in FIG. 2, the poles 101/FIG. 2 and 102/FIG. 2, are bent, deformed, folded or crushed by any combination of processes known to those skilled in the art, that form at least one base 113/FIG. 2 at least at one end, that of the core 112/FIG. 2 of the battery cell, or also at the other end of the opposite core, ends which are shown in the edges of the winding shaft.

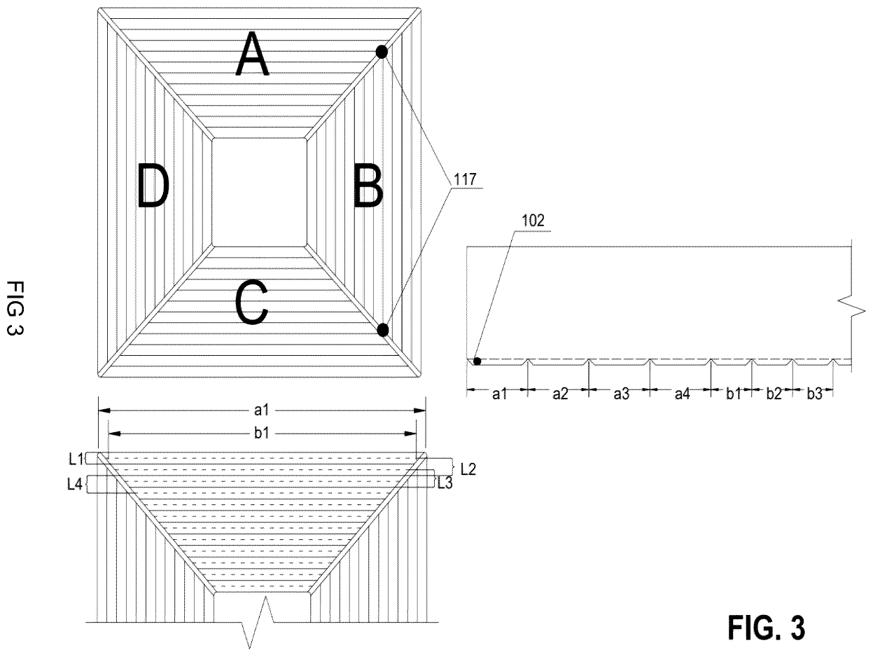

Prior to rolling, preferably at, or after tensioning and before the winding process, the poles are cut and/or cut out at the edge of the border, shown in 101/FIG. 3 (a1, a2, a3, a4, b2, b2, b3), to allow homogeneous rolling in the corners of the square axial geometric shape with areas A-B-C-D/FIG. 3.

The cutting process is before winding and can be before rolling the core of the battery cell, cutting process that can be during the tensioning of the electrode strip, respectively of the anode and/or cathode electrode strips, where the distance a1), a2), a3), a4), b1), b2), b3)/FIG. 3 etc. is calculated, as these dimensions vary depending on the rollings and on the radius of the core from the rolling axis.

Their dimensions are conditioned by the distance between the corners of the cut angles a1), FIG. 3, of the respective area which can be area A/FIG. 3, calculation of conditioning, sizing, measurement, cutting and execution by any combination of processes known to the ones skilled in the art.

At the rolled core or in the rolling process, but after tensioning, cutting and/or cutting out, the poles are bent, folded, deformed or crushed at an angle or radius, opposite to the rolling axis. The bent poles form at least one base at at least one end of the core, whereby an assembly of poles of the same type are in direct contact from one layer to another and belong to the same electrode, forming a continuity of poles of the same electrode, partially or totally overlapping, forming an electrical and thermal continuity on the entire surface of the electrode at its base.

Some embodiments of the method include bending, deforming, folding or crushing a side portion of the core, to provide a first bent, folded, deformed, pressed or crushed portion at the poles, the said base, where the poles from the at least at one end are bent and partially or completely overlap with and through their edges and/or layers represented by a1-L1 and b1-L2/FIG. 3. The cutting out and cutting of poles is done by means known by any combination of processes known to those skilled in the art, which can also be a fiber optic laser cutting in the process of tensioning on the belt.

The electrodes are rolled up around an axial geometric shape to form a roll in the initial geometric shape, but not limited to the initial axial geometric shape. The axial geometric shape is square for increased density of material in volume, more advantageous than the round or oval shape because it fills the ends and corners, it is more advantageous when assembling battery cells into modules and blocks, wherein the square shape fills the ends and corners in and from the modules and battery cell blocks, but not limited to any geometric shape, if it can allow an axis of rotation.

Another major advantage of the square geometric shape, compared to the oval geometric shape, is that it does not bend the electrodes above 90 degrees, compared to the oval geometric shape which bends the electrodes to almost 180 degrees, degrading the electrodes in the bent areas, respectively degrading the anode and cathode.

The square geometric shape of the core is preferred in the present invention which, combined with the cutouts illustrated in FIG. 3, they separate areas A-B-C-D/FIG. 3, without overlaps between areas, have delimitations 117/FIG. 3, between areas, forming a uniform base without irregularities and with large and ordered contact surfaces areas between the overlapping poles L2-L2-L3-L4/FIG. 3.

This folding and overlapping device per regions and without overlapping between regions, ensures a regular uniformity of the base of the battery cell core and an electrical and thermal conductivity in direct contact between the folds of the overlapping poles, relative to the entire surface of the electrodes, without deviating or obstructing the flow of electricity and heat, which is an integral part of the present invention.

In the continuity of the core bases 113 and 114/FIG. 2 shows the bridge device, the electric and thermal conductor collector, made of electrically and thermally conductive material, being a cushion made of copper wool or copper mesh and/or compression and deformation sponge, inside the battery cell 115 and 116/FIG. 2, attached to, in contact with and continuous for at least one base 113/FIG. 2 and/or 114/FIG. 2, and by the term cushion, it is applicable but not limited to the volume of copper, copper space, network of copper wires, copper sponge, copper fabric, as long as it has variable volume, has flexibility, it moulds, can change shape mechanically or under pressure and compression, it has a large contact surface area and it is shaped following and imprint, the copper wool cushion being produced and installed by any combination of processes known to those skilled in the art, and copper material is applicable, but without limitation to copper, as long as it is electrically conductive, thermally conductive, with a certain degree of flexibility and which can be produced in fabric, filaments, wires or blades, wherein this copper wool or copper sponge cushion device is an integral part of the present invention and which is referred to in the present invention as the conductor collector bridge.

The present invention shows at least one conductor collector bridge, which can consists in a copper wool or copper sponge cushion 115 and or 116/FIG. 2, which enters in the villosities of poles 101 and/or 102/FIG. 2, which, in their turn, they are bent, crushed or deformed, the bridge being a device that ensures a continuous, uniform, compensating contact and electrical and thermal transfer from one portion of the poles more constrained towards uniformity, forming a constant equilibrium through the large surface and by changing the shape of the copper wool or compression sponge cushion, depending on the irregularities of the battery cell core base, being an electrical and thermal sealing device, without obstruction of the electrical and thermal flow.

With continuous reference to FIG. 2, assembly: core 112/FIG. 2, with folded poles 102/FIG. 2, forming the base 114/FIG. 2, in contact and in continuity with the bridge, the electrical and thermal collector conductor, made of electrically and thermally conductive material, wool mesh and compression sponge cushion inside the battery cells 116/FIG. 2, are inserted in the battery cell box 118/FIG. 2, which may be made of aluminium or with at least one end of the aluminium box, but not limited to this material, as long as it is a rigid encapsulation and/or packaging material used as an airtight and/or packaging box, known in the field of battery cells or of batteries, by any combination of processes or materials known to those skilled in the art.

By assembling the elements in FIG. 2, all elements are non-deformable and without elastic properties, except for the bridge, the electric and thermal collector conductor, made of electrically conductive and thermally conductive material, the wool, mesh and compression sponge cushion inside the battery cells 116/FIG. 2, which, by the pressure or compression exerted by the box 118/FIG. 2, deforms and maintains an elasticity, a pressure and a permanent direct contact of the electrode assembly with the respective terminals, but also with the battery cell box, increasing the contact surface area and the capacity to continuously transmit the electrical and thermal flow through the electro-thermal chain, from the electrodes 104/FIG. 2 to box 118/FIG. 2, being at least at one edge or end of the battery cell, respectively at least at its terminal.

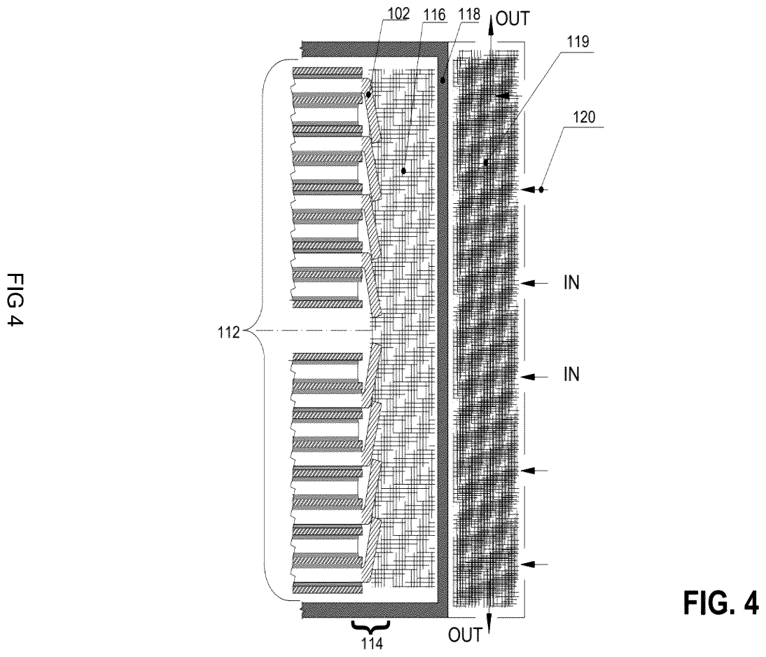

With continuous reference to FIG. 2 and also shown in FIG. 4, to the assembled elements of FIG. 2 at least one other heat exchanger 119/FIG. 4 is added, being another wool mesh and compression sponge cushion made of thermally conductive material, being a heat exchanger on the outside of the battery cell, which is an integral part of the present invention, it ensures the unobstructed continuity of the heat flow from inside the battery cell, from the electrodes 104/FIG. 1, to the poles 102/FIG. 4, to the base 114/FIG. 4, to the electrical and thermal collector conductor bridge, made of electrically and thermally conductive material inside the battery cell 116/FIG. 4, to the battery cell box 118/FIG. 4, with continuous heat flow to the outside or to another passive or forced cooling device, through the circulation “IN” “OUT”/FIG. 4.

The external heat exchanger shown in 119/FIG. 4, can be a wool mesh and compression sponge cushion made of thermally conductive material on the outside of the battery cell, which can be made of copper or Boron Nitride or Boron Nitride Composite and/or a mixture thereof, but not limited thereto, as long as it is a material with the properties described for the heat exchanger, being an integral part of the present invention.

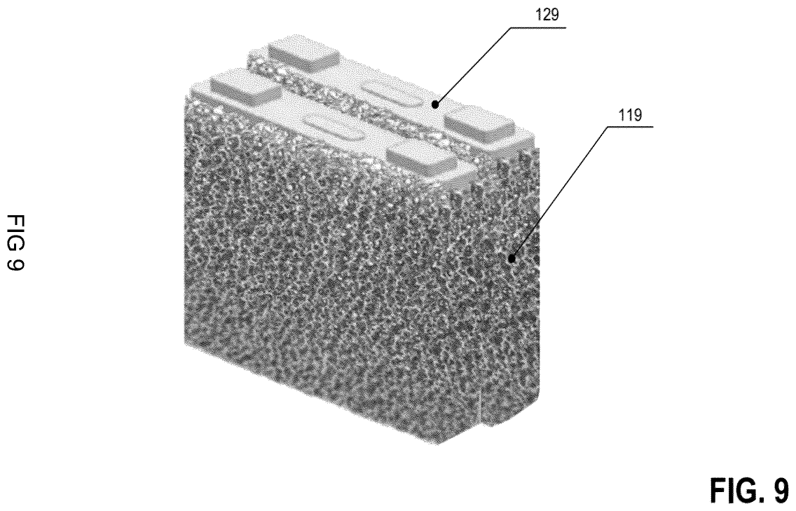

The heat exchanger may be, but without limitation to, a cushion made of copper sponge or copper wool and/or Boron Nitride and/or Boron Nitride Composite and/or a mixture or composite, as long as it provides thermal conductivity for heat transfer, attached and/or in contact with the outside of the battery cell, e,g. FIG. 9, or the battery cell is wound with the heat exchanger device 119/FIG. 9, that transmits the heat produced by the battery cell towards a passive or externally forced cooling system, it functions as a heat exchanger between the battery cell and the external environment and it is an integral part of the present invention.

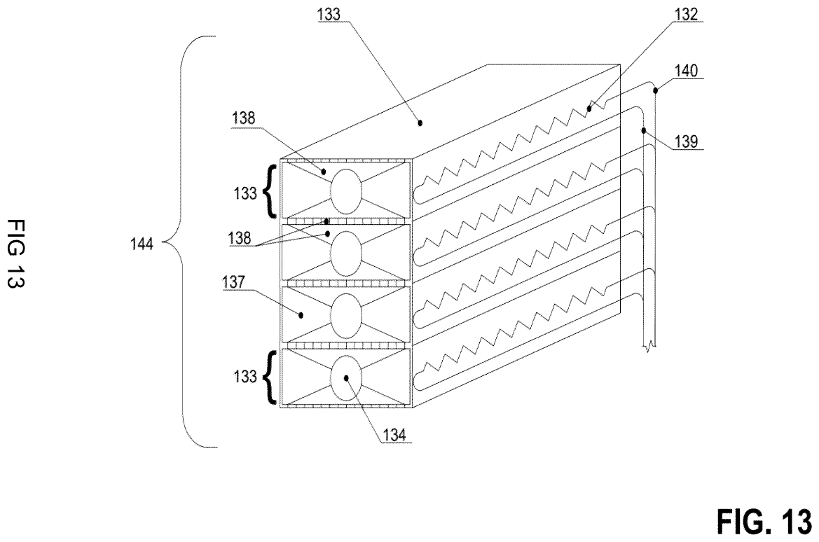

Based on the collector connector bridge device 116/FIG. 4 and the heat exchanger device 119/FIG. 4, the heat flow from inside occurs without obstruction, starting from, but not limited to, the first rolling level of the electrodes in the core of cell 102/FIG. 1 up to the passive or forced cooling source 120/FIG. 4 to the outside of the battery cell and continued up to the hybrid air-liquid-cooling system 132/FIG. 13.

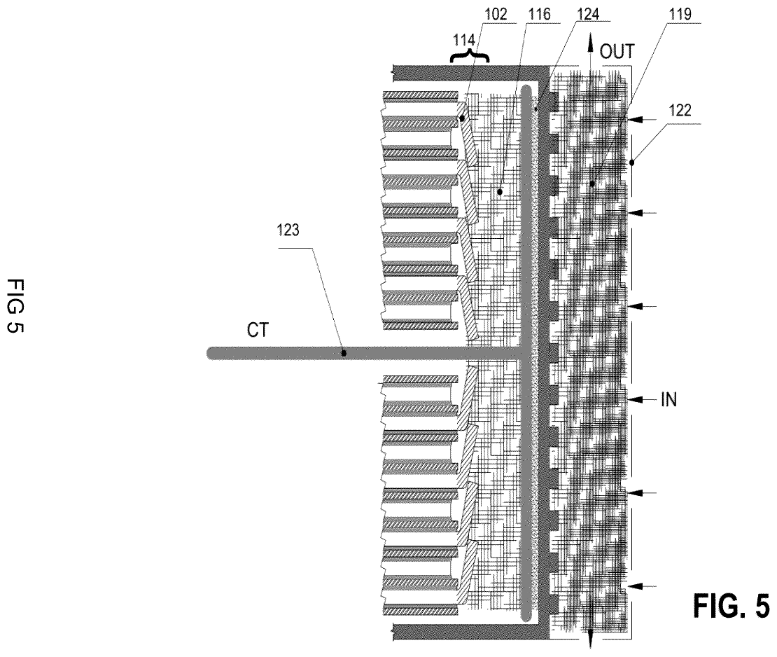

In the present invention. in FIG. 5, an electrical and thermal conductor “CT” (T-shaped conductor) is presented, being a current reverser, made of electro-thermally conductive material, solid material, represented in 123/FIG. 5, which reorients and changes the direction and conducts the electrical current to the opposite end of base 114/FIG. 5 from where it takes over the electric flow, in the direction of the axis but in the opposite direction, current taken from the bridge the electric and thermal collector conductor, made of material electrically conductive and thermally conductive, wool and compression sponge cushion inside battery cells 116/FIG. 5, but maintains and continues the thermal flow taken over from the same bridge 116/FIG. 5, which it transmits further in the same direction, at the same end of the battery cell, to the heat exchanger 119/FIG. 5, by means of the device 124/FIG. 5 which is a thermal conductor but an electrical insulator as well, and which forms an integral part of the present invention. The device material 124/FIG. 5 is Boron Nitride, but not limited to this material, as long as it is thermally conductive and at the same time an electrical insulator, made by processes and materials known in the art, but which is an integral part of the present invention.

With continuous reference to FIG. 4 and also shown in FIG. 5, the battery cell box may have a radiator 121/FIG. 5 to increase the contact area with the heat exchanger 119 FIG. 5, where the heat is concentrated, being the bridge area, the electrical and thermal collector conductor, made of electrically and thermally conductive material, wool mesh and compression sponge cushion inside the battery cell 116/FIG. 5, and the passive or forced cooling flow is done at, without limitation to, the area “IN” and “OUT”/FIG. 5.

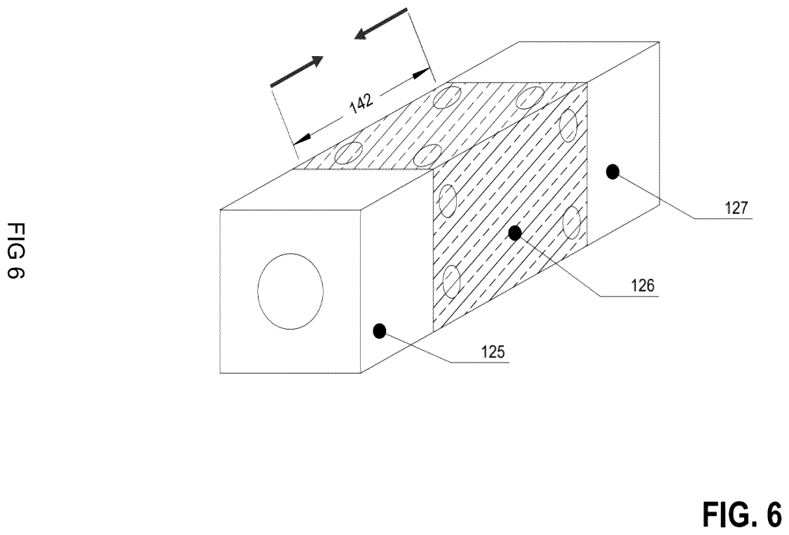

The present invention shows in FIG. 6, a composite battery cell box having a terminal at its first end 125/FIG. 6, made of electrically and thermally conductive material, solid and inflexible, being a terminal in one part of the battery cell or just one end of the battery cell box, followed by a body 126/FIG. 6, between the two ends and/or between the terminals of the battery cell, the body being made of an electrical insulating material, solid elastic and/or flexible, impermeable to liquid and gas, sealed and/or inherently hermetic. but also with the two terminals and/or ends, and at the other edge there is the other end 127/FIG. 6, another terminal of electrically and thermally conductive material or just another solid and inflexible end, being the other terminal or only the other end of the battery cell box.

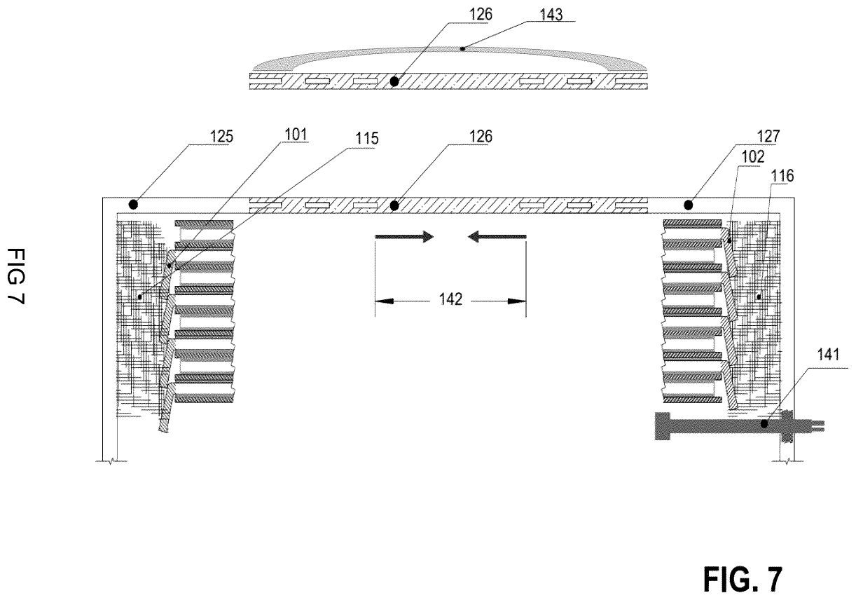

With continuous reference to FIG. 6 and also shown in FIG. 7, the vertical section of the composite box of the battery cell is shown, where 125/FIG. 7 is an electrically and thermally conductive end, being a terminal of the battery cell, made of solid and inflexible material or only one end, the device 126/FIG. 7 is the body between the two ends 125 and 127/FIG. 7, the body being an electrical insulator, made of elastic and/or flexible solid material and impermeable to liquid and gas and wherein 127/FIG. 7 is the other end, electrically and thermally conductive being the other terminal, or only the other of the battery cell. There is at least one conductor collector bridge 116/FIG. 7 between the two ends and terminals and inside the composite battery cell housing on which pressure or compression 142/FIG. 7 of the elastic and/or flexible body 126/FIG. 7 is exerted and which ensures and increases the contact surface and the electrothermal flow between at least one terminal of the end 127/FIG. 7 and the base with poles 102/FIG. 7.

The body part 126 of FIG. 6 and FIG. 7, ensures the tightness of the battery cell, being an impermeable material such as silicone rubber, without limitation hereto, as long as it is elastic and/or flexible, electrical insulating, impermeable, tight and resistant to temperatures above the operating conditions of the battery cell, and through the elasticity of the body 126 FIG. 6, respectively, 126 FIG. 7, the body device exerts pressure or compression 142/FIG. 7 on the assembly represented in FIG. 7, on the poles and bases of the battery cell, on the ends of terminals 125, 127/FIG. 7, it compresses at least one electrical and thermal conductor collector bridge, made of electrically conductive and thermally conductive material, consisting of wool mesh and compression sponge cushion 116/FIG. 7, respectively, 115/FIG. 7, from inside the battery cell, such pressure or compression being to and between at least one base and its terminal, such bridge increasing in turn the contact area and the contact pressure between the poles, bases and the terminal with the battery cell box, at least one terminal 125/FIG. 7 with the bridge 115/FIG. 7 and/or respectively at the other terminal 127/FIG. 7, as well, with the other contactor collector bridge 116/FIG. 7. The flexible body 126 FIG. 6 and 126 FIG. 7, may or may not be limited to a flexible composite material, being part of a semi-elastic solid composite box device, representing the battery cell box containing the assembly: core, at least one pole base, at least one contactor collector bridge and at least a terminal, battery cell assembly, but not limited thereto, wherein the devices, elements and assembly being an integral part of the present invention, with the thermoelectric flow chain, assembly which can be made by direct contact, pressing and/or compression, seamless and executed by any combination of processes known to those skilled in the art.

The present invention shows in FIG. 2 a pressure measuring device 141, inside the battery cell, which measures the internal pressure and translates the information to the controller, if gas is formed inside the battery cell. The formation of gas inside the cell is a dangerous result because it is flammable, due to the malfunction of the battery cell, from the electrochemical reaction inside them from the anode and cathode, which forms a pressure, deforms and breaks the box or the packing of the battery cells and exposes the battery cells or the entire battery cell assembly to explosion or combustion. With continuous reference to FIG. 6 and FIG. 7, the flexible and elastic body 126/FIG. 7, is also an expansion vessel shown in 143/FIG. 7 which, in case of formation of gas inside the battery cell and/or in case of malfunction of the battery cell, the expansion vessel controlling the internal volume variation, contains and stores the flammable and explosive gas inside, isolates the flammable and explosive gas produced by the anode/cathode from the external environment through the body 126/FIG. 7 being tight and maintains an internal pressure below the battery cell box breakage limits under the breakage pressure or under the forced discharge or leakage pressure of gas in the external environment, combustible gas produced and formed only on the inside.

The body 126/FIG. 7 is also a device in combination with the pressure sensor 141/FIG. 7, being an expansion vessel 143/FIG. 7 of the flammable and explosive gas that may form inside the battery cell, the expansion vessel having variable volume, maintains pressure below the limits of breakage, cracking or leakage of gas from the battery cell box to the outside, which allows the pressure sensor to transmit internal pressure data confirming the electrochemical reaction, real-time data confirming that the released gas is a danger to the battery cell assembly, wherein the process is monitored from the beginning of the electrochemical reaction, it extends the time in which an intervention can be activated to save, isolate or change the relevant battery cell, due to the ability of the gas to accumulate inside the battery cell since the beginning of the inside gas formation, since the beginning of the reaction that produces gas and pressure, the time necessary to intervene with the process of stopping the battery cell charging or discharging process and to secure the battery cell, respectively, the battery cells assembly into modules.

Through the gas detection processes and solutions at the module assembly level known prior to this invention, the presence of gas is detected at the level of modules or blocks, the intervention is late and limited, because the flammable and explosive combustible gas already existed inside the battery cells, modules and blocks, entering the volume of the electrical energy storage assembly by ventilation and cooling, the battery cell or cells releasing and losing gas is/are not known, and the danger is imminent.

In the present invention, the expansion vessel device of the body 126 FIG. 6 and 143/FIG. 7, stores the gas, allows safe pressure increase without loss to the outside of the battery cell, and the pressure sensor transmits data that can be in real-time, right from the beginning of the reaction that produces flammable and explosive gas inside the cell, without endangering the battery cell assembly for electrical energy storage. The pressure sensor 141/FIG. 2 and FIG. 7 can be connected to the battery cell BMS, which in turn is connected to each battery cell and with a logic or MCU controller with Inputs and Outputs, which can transmit real-time pressure data and for each battery cell, separately, processes that can be performed with existing knowledge and equipment of industry professionals, but where the body device 126/FIG. 7 which becomes an expansion vessel 143/FIG. 7 and the internal pressure sensor 141/FIG. 7 and FIG. 2, of the battery cell, are an integral part of the present invention.

The pressure sensor 141/FIG. 2 and FIG. 7 is also represented by a pressure emitter, and/or pressure transducer, without limitation hereto, as long as it detects the internal pressure in the battery cells and transmits it in any form known in the industry, to the outside, such pressure confirming an electrochemical reaction inside the battery cell.

All electrical energy storage systems with battery cells are equipped with gas, hydrogen detectors, at the level of all modules or battery cell assemblies, to detect the external atmosphere of the battery cells in real time and to detect the malfunction of the battery cells, due to the fact that in the case of gas production, under pressure and fast, the combustible gas is exfiltrated to the outside of the battery cells, the battery cells being rigid and without internal volume space, where the gas leaked to the external environment posing a major risk of explosion or combustion of the entire system. In the present invention, the body device 126/FIG. 6, respectively, 126/FIG. 7, which is also the expansion vessel 143 FIG. 7, is the solution to contain and store under pressure the gas produced on the inside by the malfunction of the battery cell and, in combination with the pressure sensor 141 FIG. 2 and FIG. 7, it starts the intervention process and the control of the risk of explosion or combustion, prior to losing gas from inside the cell to the outside, without losses to the external environment, in modules or in the blocks of battery cell assemblies, where the combined device: expansion vessel/internal pressure sensor of the battery cell is an integral part of the present invention and can be achieved by processes known to those skilled in the art.

Hereinafter, with continuous reference to FIG. 6, also shown in FIG. 7, the flexible and elastic body 126/FIG. 7 acts as an axial pressure device 142/FIG. 7 on the assembly: anode and cathode core, base, conductor collector bridge, terminal, box, having the property of maintaining the pressure and/or contact axial compression, seamless between the elements, ensuring the continuous electrical and thermal flow, in and inside the battery cell, without obstruction of surfaces and/or shapes.

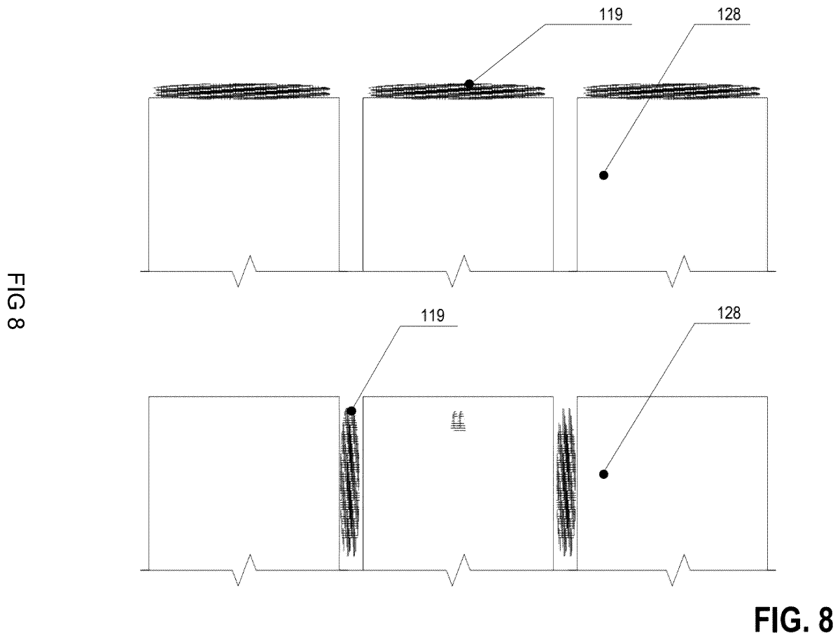

With continuous reference to at least one figure among FIG. 1 to FIG. 7 and/or to a group of figures, also shown in FIG. 8, battery cells 128/FIG. 8 are assembled in groups, modules, blocks and/or packs, and the heat exchanger device made thermally conductive material, wool mesh and compression sponge cushion on the outside of the battery cells are attached and fixed between the battery cell boxes 128/FIG. 8 and in contact with the walls of the boxes, to ensure the cooling of the battery cells, being heat exchangers 119/FIG. 8 which may partially or totally envelop and/or cover the battery cells, without limitation to enveloping or covering, horizontally and/vertically, without limitation to enveloping or covering, as long as they enter the cooling flow of the battery cells and which are an integral part of the present invention.

With continuous reference to FIG. 8, also shown in FIG. 9, the heat exchanger device 119/FIG. 9 also applies to battery cells 129/FIG. 9 of the prismatic type, which are an integral part of the present invention, by making assemblies of modules and blocks by any combination of processes known to those skilled in the art. Prismatic battery cells are cooled with and through heat exchangers 119/FIG. 9 embedded between the prismatic battery cells, in contact with their surfaces and in the spaces between the prismatic battery cells, which fills the spaces between the prismatic battery cells, spaces which may be subject to volume change between the battery cells, however the heat exchanger device 119/FIG. 9 ensures the thermal conductivity and continuity and the thermal flow chain with the passive or forced cooling systems, such heat exchangers being made of thermally conductive material, wool mesh and compression sponge cushion outside the battery cells 119/FIG. 9, their cooling is ensured by passive, forced or, air-liquid hybrid cooling sources.

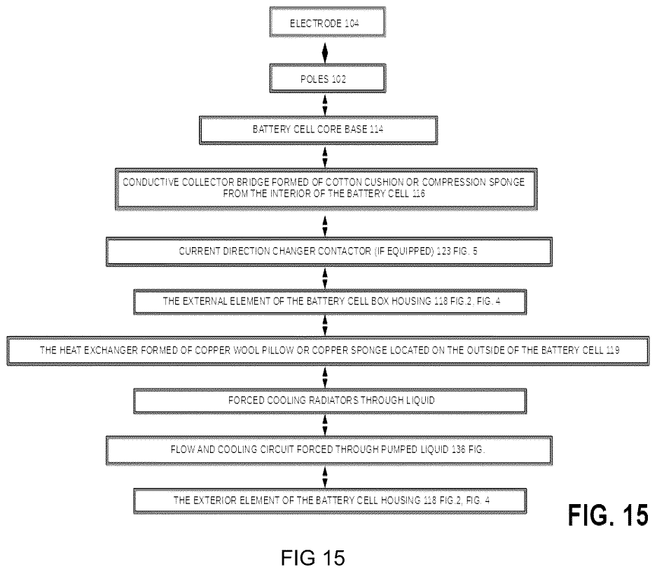

With continuous reference to FIG. 8, also shown in FIG. 9, the heat exchanger device made of thermally conductive material, wool mesh and compression sponge cushion on the outside of the battery cells 119/FIG. 9, also applies to battery cells 131/FIG. 9 of prismatic type and/or to battery cells in solid box and/or rigid box and/or composite box shown in FIG. 6, without limitation to the shape or housings of said battery cells, as long as they have thermal flow from inside the battery cells and can be cooled by the continuity of the thermal flow chain, and/or the total or partial continuity of the system of the invention shown in FIG. 15 which is an integral part of the present invention.

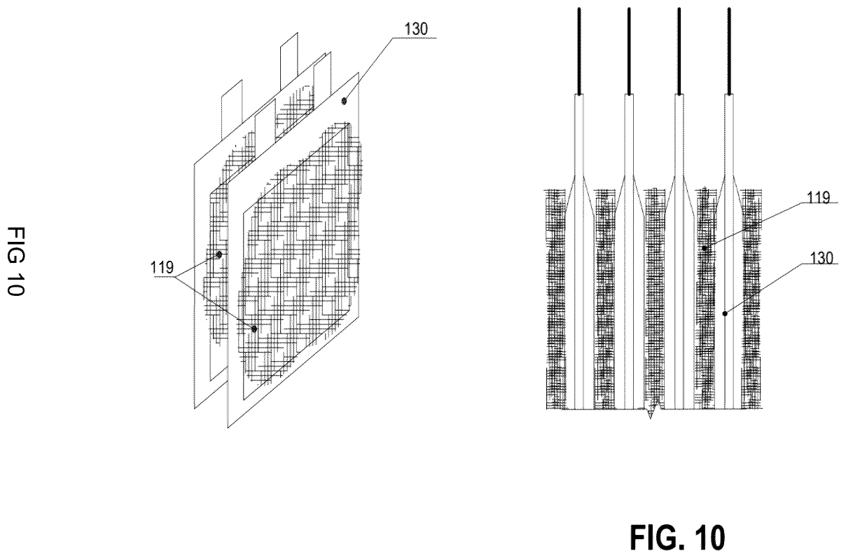

With continuous reference to FIG. 8, also shown in FIG. 10, the heat exchanger device made of thermally conductive material, wool mesh and compression sponge cushion on the outside of the battery cells 119/FIG. 10, also applies to battery cells 130/FIG. 10 of the pouch type, which are an integral part of the present invention. Pouch battery cells are cooled with and through heat exchangers 119/FIG. 10, embedded between the pouch battery cells, in contact with their surfaces and in the spaces between the pouch battery cells, which fills the spaces between the pouch battery cells, such spaces being subject to volume change between the pouch battery cells, however they ensure thermal conductivity and continuity and the thermal flow chain with the passive or forced cooling systems, where heat exchangers made of thermally conductive material, wool mesh and compression sponge cushion outside the battery cells 119/FIG. 10 ensure their cooling under variable volume conditions, and which can be cooled in turn by passive, forced or air-liquid hybrid cooling sources.

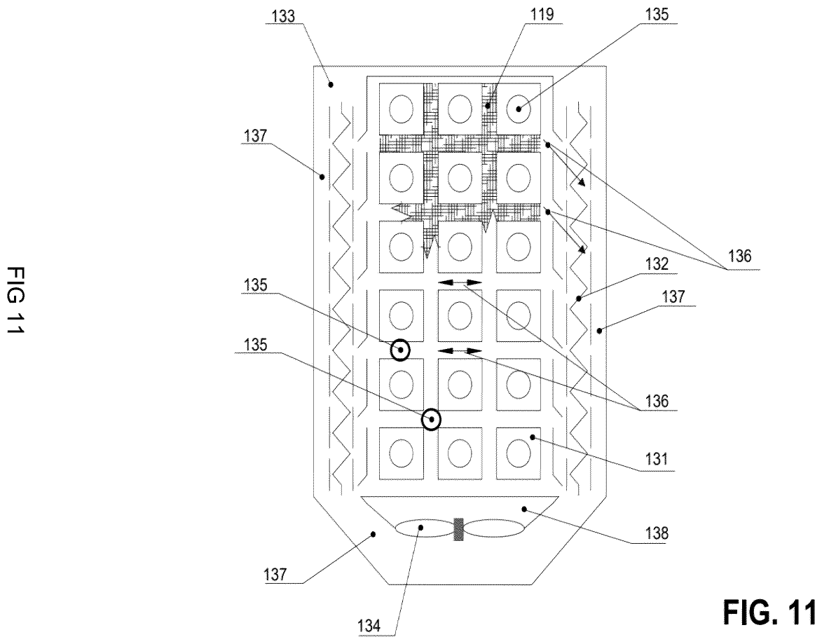

The present invention provides the battery cell module of the present invention FIG. 11, which may consist of at least two battery cells, with the chain and the continuous thermal flow FIG. 15, in horizontal view, which may be a liquid air (gas) hybrid chain, represented by battery cells 131/FIG. 11 which radiate heat, taken over by the heat exchangers 119/FIG. 11, which are in contact with the battery cells 135/FIG. 11, conducting heat by passive or forced flow to the cooling radiators 132/FIG. 11, in their turn cooled by, but not limited to, liquid-cooling system, as long as they absorb heat from the flow coming from the heat exchangers 119/FIG. 11 and remove the heat out of the battery cell module assembly 133/FIG. 11.

The cooling flow of the module of the present invention can be air or air-liquid hybrid, which can be forced, provided by the front fan 134/FIG. 11 which provides the closed or semi-closed cooling circuit, without limitation hereto, the cooling circuit of the battery cell module 133/FIG. 11, wherein fan 134/FIG. 11 provides the forced cooling flow through the battery cells 131/FIG. 11 and ensures the hybrid system thermal change, from the air or gas between the battery cells 131 to the radiators 132/FIG. 11, in their turn being cooled by a liquid-cooling circuit flow.

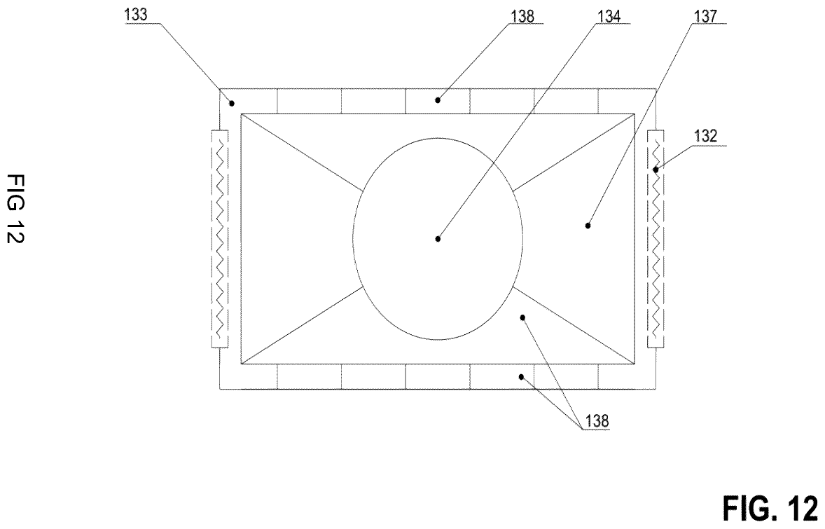

With continuous reference to FIG. 11 and also shown in FIG. 12, the present invention shows the vertical view of the battery cell module 133/FIG. 12, wherein 132/FIG. 12 are the liquid-cooling radiators, 134/FIG. 12 is the front fan of the battery cell module, 137/FIG. 12 is the suction area of fan 134/FIG. 12 which sucks cooled cold air from the radiators 132/FIG. 12 and which forcibly pushes cold air into areas 138/FIG. 12 below and above the battery cells, which form a higher positive pressure in areas 138/FIG. 12 with the cold air flow, compared to the pressure in area 136/FIG. 11, cold air flow which is constantly and evenly distributed through holes 135/FIG. 11 above and below the battery cells in the module, in the place or area of the heat exchangers of the battery cells. Constant cold air flow, which in its turn, through holes or orifices 135/FIG. 11, homogeneously cools the heat exchangers adjacent or in contact with the battery cell box 119/FIG. 11, which are arranged but not limited to the arrangement of FIG. 8 and/or FIG. 9, where there is higher pressure in area 138/FIG. 12 than in areas of heat exchangers 136/FIG. 12, creating the area of cold air flow that becomes constant by obstructing the holes 135/FIG. 11, ensuring the cooling uniformity and homogeneity of the battery cell module. From inside the pack and from the heat exchangers 119/FIG. 11, heat and hot air is conducted through closed or semi-closed flow from areas 136/FIG. 11, to areas 137/FIG. 11, though suction by fan 134/FIG. 11 12 respectively the suction of areas 137/FIG. 12, which is a forced suction from directions 136/FIG. 11 and/or their edges, pass through the cooling radiators 132 FIG. 11, respectively, 132 FIG. 12, completing the closed or semi-closed air-liquid hybrid cooling circuit cooling air circuit of the battery cell module 133/FIG. 11 respectively 133/FIG. 12, forming an integral part of the present invention.

With continuous reference to FIG. 11 and FIG. 12, and also shown in FIG. 13, the present invention shows the assembly of battery packs and modules in racks which may be an electrical energy storage device 144/FIG. 13 which can be superimposed and/or stacked, but not limited to this scaling, with an independent air-liquid hybrid cooling system and central or common liquid-cooling circuit, without limitation thereto, as long as the cooling system reaches each module 133/FIG. 13, to/or from each radiator 132/FIG. 13 and ensures a cooling continuity which can be constant in the battery cells, which in turn are in closed or semi-closed cooling system and form an integral part of the present invention. The rack cooling system 144/FIG. 13, which is common, may be liquid, is supplied by a cooling circuit with liquid pumped by a pump, through pipes 139/FIG. 13 and 140/FIG. 13 attached to rack 144/FIG. 13 and which supplies the radiators 132/FIG. 13 on both sides of modules 133/FIG. 13 and/or, respectively, both sides of rack 144/FIG. 13.

Module assembly 133 shown in FIG. 13, may contain modules with their own forced and/or hybrid cooling system, with front fan 134/FIG. 13, side radiators 132/FIG. 13, suction areas 137/FIG. 13, push areas 138/FIG. 13 and heat exchangers inside the modules among the modules' battery cells, at each module or by groups of modules, represented in FIG. 13 and being an integral part of the present invention.

Battery cell modules or blocks 133/FIG. 13 can be removable and can be assembled and disassembled, mountable and unmountable, as drawers in shelves, without interference or physical, mechanical and/or thermal conflict, with the liquid-cooling circuit, wherein, in their turn, the radiators are lateral, fixed, with liquid-cooling circuit of the rack which is a device for storing electricity, separate liquid-cooling circuit with the forced air-cooling flow of the battery cell modules.

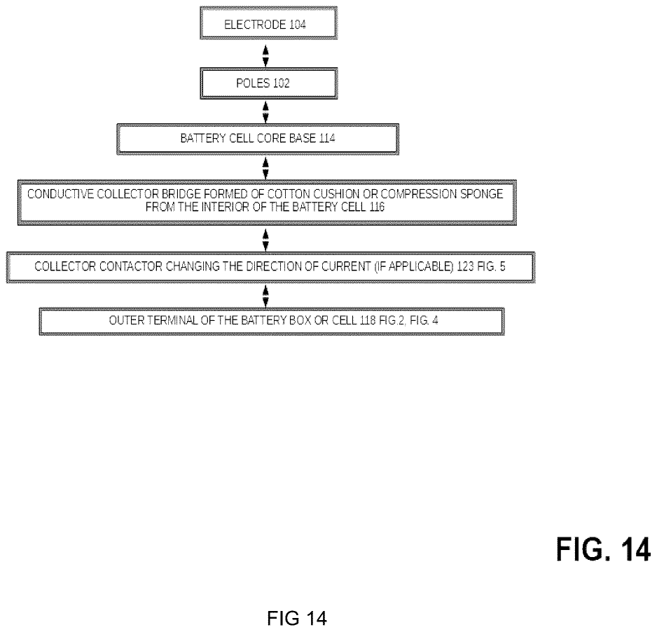

The continuous flow and the electric chain are represented in FIG. 14 reversibly and in two directions, without obstruction or limitation by materials, knots, welds or surface area, of the surfaces or contact area between elements, from electrode 104/FIG. 1, to the poles 102/FIG. 1, to the base of the battery cell core 114/FIG. 2 through their poles 102/FIG. 2, to the bridge of the electrical and thermal conductor collector, made of electrically conductive and thermally conductive material, the wool mesh and compression sponge cushion inside the battery cell 116/FIG. 2, to the CT current reversing contactor 123 FIG. 5, if applicable, and to the outer terminal of the battery cell box 118 FIG. 2 and/or 118/FIG. 4, being an assembly of continuous flow and electrical conductivity chain which is an integral part of the present invention and made by any combination of processes known to those skilled in the art.

The continuous flow and thermal chain of the present invention are shown in FIG. 15 reversibly and in two directions, without obstruction or limitation by materials, knots, welds or surface area of the surfaces or contact area between elements, from electrode 104/FIG. 1, to the poles 102/FIG. 1, to the base of the battery cell core 114/FIG. 2 through their poles 102/FIG. 2, to the bridge of the electrical and thermal conductor collector, made of electrically conductive and thermally conductive material, the wool mesh and compression sponge cushion inside the battery cell 116/FIG. 2, to the CT current reversing contactor 123 FIG. 5, if applicable, and to the outer terminal of the battery cell box 118 FIG. 2 and/or 118/FIG. 4, to the heat exchanger device made of thermally conductive material, wool mesh and compression sponge cushion on the outside of the battery cells 119/FIG. 4, to the forced liquid-cooling radiators 132/FIG. 11, respectively, 132/FIG. 12 and 132/FIG. 13, through the air-liquid hybrid cooling flow 136/FIG. 11, to the central liquid-cooling system 139-140 FIG. 13, with forced circuit through the water pump, being an assembly of continuous flow and thermal conductivity chain which is an integral part of the present invention and made by any combination of processes known to those skilled in the art. closed cooling system and form an integral part of the present invention. The rack cooling system 144/FIG. 13, which is common, may be liquid, is supplied by a cooling circuit with liquid pumped by a pump, through pipes 139/FIG. 13 and 140/FIG. 13 attached to rack 144/FIG. 13 and which supplies the radiators 132/FIG. 13 on both sides of modules 133/FIG. 13 and/or, respectively, both sides of rack 144/FIG. 13.

Module assembly 133 shown in FIG. 13, may contain modules with their own forced and/or hybrid cooling system, with front fan 134/FIG. 13, side radiators 132/FIG. 13, suction areas 137/FIG. 13, push areas 138/FIG. 13 and heat exchangers inside the modules among the modules' battery cells, at each module or by groups of modules, represented in FIG. 13 and being an integral part of the present invention.

Battery cell modules or blocks 133/FIG. 13 can be removable and can be assembled and disassembled, mountable and unmountable, as drawers in shelves, without interference or physical, mechanical and/or thermal conflict, with the liquid-cooling circuit, wherein, in their turn, the radiators are lateral, fixed, with liquid-cooling circuit of the rack which is a device for storing electricity, separate liquid-cooling circuit with the forced air-cooling flow of the battery cell modules.

The continuous flow and the electric chain are represented in FIG. 14 reversibly and in two directions, without obstruction or limitation by materials, knots, welds or surface area, of the surfaces or contact area between elements, from electrode 104/FIG. 1, to the poles 102/FIG. 1, to the base of the battery cell core 114/FIG. 2 through their poles 102/FIG. 2, to the bridge of the electrical and thermal conductor collector, made of electrically conductive and thermally conductive material, the wool mesh and compression sponge cushion inside the battery cell 116/FIG. 2, to the CT current reversing contactor 123 FIG. 5, if applicable, and to the outer terminal of the battery cell box 118 FIG. 2 and/or 118/FIG. 4, being an assembly of continuous flow and electrical conductivity chain which is an integral part of the present invention and made by any combination of processes known to those skilled in the art.

The continuous flow and thermal chain of the present invention are shown in FIG. 15 reversibly and in two directions, without obstruction or limitation by materials, knots, welds or surface area of the surfaces or contact area between elements, from electrode 104/FIG. 1, to the poles 102/FIG. 1, to the base of the battery cell core 114/FIG. 2 through their poles 102/FIG. 2, to the bridge of the electrical and thermal conductor collector, made of electrically conductive and thermally conductive material, the wool mesh and compression sponge cushion inside the battery cell 116/FIG. 2, to the CT current reversing contactor 123 FIG. 5, if applicable, and to the outer terminal of the battery cell box 118 FIG. 2 and/or 118/FIG. 4, to the heat exchanger device made of thermally conductive material, wool mesh and compression sponge cushion on the outside of the battery cells 119/FIG. 4, to the forced liquid-cooling radiators 132/FIG. 11, respectively, 132/FIG. 12 and 132/FIG. 13, through the air-liquid hybrid cooling flow 136/FIG. 11, to the central liquid-cooling system 139-140 FIG. 13, with forced circuit through the water pump, being an assembly of continuous flow and thermal conductivity chain which is an integral part of the present invention and made by any combination of processes known to those skilled in the art.

1. A battery cell, with at least one assembly of electrodes, anode and cathode, covered up to the border of the poles with active composite material arranged in reflection, where the border of the anode pole is opposite to the edge of the cathode pole, with at least one border of poles bent, to form a base at at least one end, where it is continued with at least one electrically and thermally conductive collector bridge, being a wool mesh or compression and contact sponge cushion, which together with the electrode assembly form a battery cell core, which is packed in a battery cell box, comprising:
separator between the anode and cathode electrodes;
the anode and cathode electrodes, with poles and at least one separator, are rolled onto a geometrically shaped central axis to form a wrapped roll;
the poles at least one end are bent and partially or completely overlap with and through their edges and/or their layers, which form a base;
electrical and thermal conductor collector bridge made of electrically conductive and thermally conductive material, wool mesh and compression sponge cushion, continuously and/or attached at at least one end to at least one base consisting of poles, bridge that moulds and is in direct contact and pressure or compression, both on the surface of the core base and on the surface of the battery cell terminal or of the inner face of the battery cell box, bridge that enters the villosities of the base surface, increases its contact surface area by pressure or compression, fills the free spaces between the electrode roller and the battery cell box and/or forms a continuous electrothermal chain with its terminal;
box having a flexible and/or elastic body, located between the ends of the core or between the terminals of the battery cell, such body being airtight with the walls of the box and airtight with the outside of the box, which may be made of electrically insulating material;
box with internal pressure sensor, internal pressure transmitter, internal pressure transducer, inside the box and/or inside the battery cell, to measure the internal pressure and to detect the gas resulting from the electrochemical reaction of the battery cell electrodes.

2. The battery cell of claim 1, further comprising electrodes rolled onto a geometrically shaped central axis, which may form a roll wound with the geometric shape of the core, with at least one border of an electrode cut on a band in comers, for the uniform wrapping and bending of the layers from the base, respectively, and between the edges of the base areas.

3. The battery cell according to claim 1, further comprising the flexible and/or elastic body, as an internal expansion vessel device of the battery cell, for the gas inside the battery cell, being an internal volume exchanger hermetically sealed with the outside of the battery cell, specific for the gas produced by the battery cells by electrochemical reaction between the anode and the cathode, with the property of storing the gas under pressure on the inside, storage below the critical level of box breakage or loss of the inside gas the outside of the battery cell.

4. The battery cell according to claim 1, further comprising the flexible and/or elastic body as an axial pressure and/or compression device upon the core assembly composed of: anode and cathode, base, conductor collector bridge, terminal, and at least one inner face of the box, axial pressure device with the property of maintaining the pressure and/or the axial contact compression of the seamless assembly between the elements, ensuring the continuous electric and thermal flow, inside the battery cell, without obstruction of surfaces and/or shapes of the elements.

5. The battery cell according to claim 1, further comprising a heat exchanger device comprised of a thermal conductor, a wool mesh and compression sponge cushion made of thermally conductive material located outside the battery cell, forming the pouch battery cell, respectively, the prismatic battery cell, attached to and in contact with the outer wall of the battery cell box, which can be positioned, but not limited to, at the level of the electrical and thermal conductor collector bridge area inside the battery cell, heat exchanger device of the present claim which takes over the continuous thermal flow from the said conductor collector bridge, respectively, from the anode/cathode core inside the battery cell or from the thermal radiation areas of the pouch and/or prismatic cells, and transmits heat continuously to an external passive or forced cooling system.

6. The battery cell of claim 1, further comprising an internal pressure sensor, and/or pressure emitter, and/or pressure transducer, in or within the battery cell, or, in or within the battery cell box, which can be connected to the battery cell BMS and/or MCU controller with “inputs” and “outputs”, to transmit in real time the pressure and formation of flammable gas from at the beginning of the reaction between the anode and the cathode, electrochemical reaction between the electrodes that produces combustible, explosive gas.

7. A cell module comprising at least two battery cells according to claim 1, wherein the module further comprises an assembly of heat exchangers consisting of a thermal conductor, wool mesh and compression sponge cushion made of thermally conductive material, placed between the battery cells and/or wrapping the battery cells and/or filling the spaces between the battery cells, without limitation to the surface, volume or shape, heat exchangers that continuously transmit the thermal flow of the battery cells to a passive or active cooling system which may be a separate cooling system of the module.

8. The cell module according to claim 7, wherein the module comprises:
front fan, with push areas, of the cold flow, above and below the battery cells and with side suction areas;
holes above and/or below the battery cells, which direct the cold flow to the cooling areas, which obstruct the cold flow and increase the pressure in the cold flow push areas, render the flow uniform and the cooling constant on all cold flow distribution surfaces, up to the battery cell heat exchangers;
cold flow suction zones, with absorption and/or suction through, among the battery cells with their heat exchangers and/or the sides of the battery cells, continued through the zones with liquid-cooling radiators, lateral radiators of the module and/or at the edges.

9. The cell module according to claim 7, further comprising at least one pouch battery cell or pouch battery cell assembly and/or at least one prismatic battery cell or prismatic battery cell assembly, the module comprising:
consisting of thermal conductor, wool mesh and compression sponge cushion made of thermally conductive material, placed between the battery cells and/or wrapping the battery cells and/or filling the spaces between the battery cells, without limitation to the surface, volume or shape, heat exchangers that continuously transmit the thermal flow of the battery cells to a passive or active cooling system which may be a cooling system of the module;
front fan with cold flow push areas, above and below the battery cells and the cold flow suction area through the sides;
holes above and/or below the battery cells, which direct the cold flow to the cooling areas, which obstruct the cold flow and increase the pressure in the cold flow push areas, render the flow uniform and the cooling constant on all cold flow distribution surfaces to the battery cell heat exchangers;
cold flow absorption areas, among the battery cells with their heat exchangers and/or the sides of the battery cells, continued through the areas with liquid-cooling radiators, lateral radiators of the module and/or at the edges.

10. A rack which is an electrical energy storage device comprising an assembly of at least two modules according to claim 7, hybrid air-liquid cooling modules, with which the module assembly forms a rack, comprising side cooling radiators of the rack, at the edge of the modules and/or at the side edges of the rack, with liquid-cooling pumped by a central pump, wherein the modules are removable and can be assembled and disassembled without interfering with the liquid-cooling system, modules that can be assembled and disassembled as drawers in shelves, without interference or technical conflict, with radiators and/or with the cooling circuit functioning on liquid on the sides of the modules and/or technical conflict with the fixed, central liquid cooling flow or circuit of the rack.
